(19) United States
(12) Patent Application Publication
(10) Pub. No.: US 2007/0171128 A1
(43) Pub. Date: Jul. 26, 2007

(54) Planar antenna with short-trace

(75) Inventor: I-Fong Chen, Tao-Yuan City (TW)

Correspondence Address: BRUCE H. TROXELL, SUITE 1404, 5205 LEESBURG PIKE, FALLS CHURCH, VA, 22041, US

(73) Assignee: Auden Techno Corp.

(21) Appl. No.: 11/335,554

(22) Filed: Jan. 20, 2006

(51) Int. Cl. H01Q 1/38

(52) U.S. Cl. 343/700 MS

(57) ABSTRACT

A planar antenna with a short-trace applied to multi-band mobile handset electronic devices, the structure includes two main resonant elements that are bent around each other and the short-trace, the short-trace is connected between a feed-point and a ground-point; by influence of a loop surface current induced by the short-trace, the antenna gets a broadband effect at multi-frequencies.

### BACKGROUND OF THE INVENTION

1. Field of the Invention

The present invention is related to a planar antenna, and especially to a planar antenna with a short-trace between a feed-point and a ground-point, in order that the antenna can get a broadband effect at multi-frequencies.

2. Description of the Prior Art

By advancing of the wireless communication technique, multi-band mobile handset electronic devices including mobile phones, PDA's and GSM's have been quite prevailed.

A planar antenna design for a kind of PIFA (planar inverted-F antenna) has been developed to get an antenna applicable to such multi-band mobile handset electronic devices, in which plural cuts are provided on the main body of a planar antenna with a feed-point and a ground-point and are arranged to form an inverted “F” shape, and two radiating elements are formed to form different loops, this can obtain a broadband antenna allowing receiving of two kind of bands.

However, the shape of such a normal planar antenna basically is designed according to the forms of the inner housing of a mobile phone. In practical application, such as on the mobile phone, because of a requisition for a finite size, the inner housing is insufficient in height, this reduces the bandwidth of the antenna.

### SUMMARY OF THE INVENTION

In order to solve the problem resided in the conventional technique, the present invention provides a planar antenna with a short-trace, this structure includes two main resonant elements that are bent around each other and a short-trace, the short-trace is connected between a feed-point and a ground-point; by influence of a loop surface current induced by the short-trace, the antenna can get a broadband effect at multi-frequencies.

Moreover, the planar antenna with a short-trace provided in the present invention can have the bandwidth increased for a GSM band.

To tune to optimize the location and the trace-width of the short-trace of the present invention, the best impedance matching can be obtained.

The present invention will be apparent in its structural features and effects in using after reading the detailed description of the preferred embodiment thereof in reference to the accompanying drawings.

### BRIEF DESCRIPTION OF THE DRAWINGS

FIG. 1 is a perspective view showing the appearance of the present invention;

FIG. 2 is developed plan view of an antenna of FIG. 1;

FIG. 3 shows a drawing of a radiation field of the antenna before adding with a short-trace of the present invention;

FIG. 4 shows a drawing of a radiation field of the present invention;

FIG. 5 shows another preferred embodiment of the present invention.

### DETAILED DESCRIPTION OF THE PREFERRED EMBODIMENT

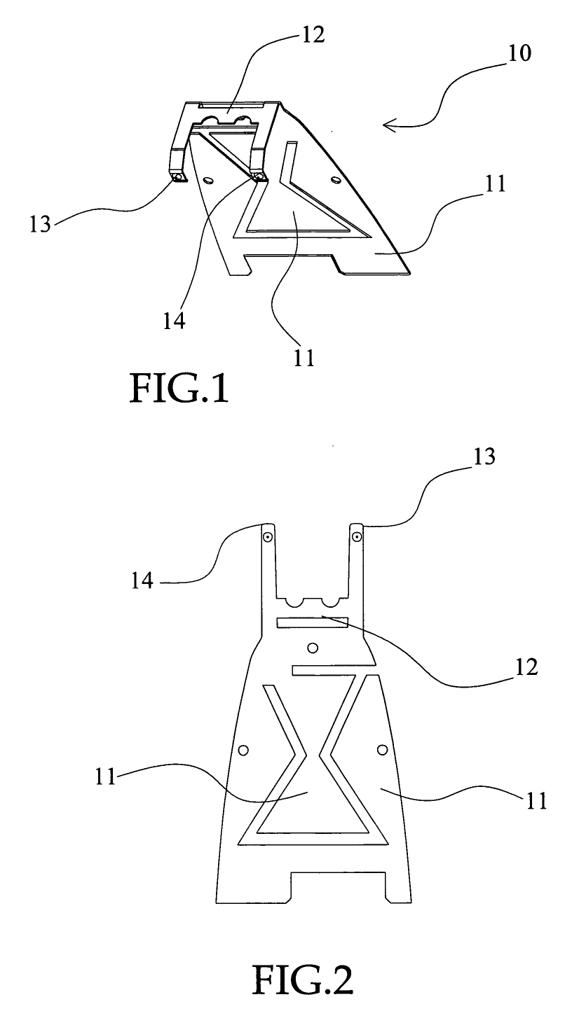

Referring to FIGS. 1 and 2, the structure of a planar antenna 10 of the present invention comprises two main resonant radiating elements 11 that are bent around each other and a short-trace 12; the short-trace 12 is connected between a feed-point 13 and a ground-point 14 of the antenna and is made by etching of a copper base plate, and a plastic holder is provided beneath the short-trace 12.

Resonant frequencies of the antenna 10 can take a quarter wavelength as a unit of changing in adjusting to change the sizes of the two main resonant radiating elements 11.

In practical application, because of a requisition for a finite size, the inner housing provided for the planar antenna 10 is insufficient in height; this reduces the bandwidth of the antenna. To compensate such an environmental problem, the present invention has the short-trace 12 connected between a feed-point 13 and a ground-point 14 of the antenna to separate resonators. By virtue that the short-trace 12 can induce a loop surface current of the antenna, the antenna can get a broadband effect at multi-frequencies.

In FIG. 1, the bandwidth is set according to the sizes of the two main resonant radiating elements 11 and the position of the short-trace 12. If the position of the short-trace 12 is changed, the bandwidth can be increased for being applied to a GSM band. To tune to optimize the location and the trace-width of the short-trace 12, the best impedance matching can be obtained.

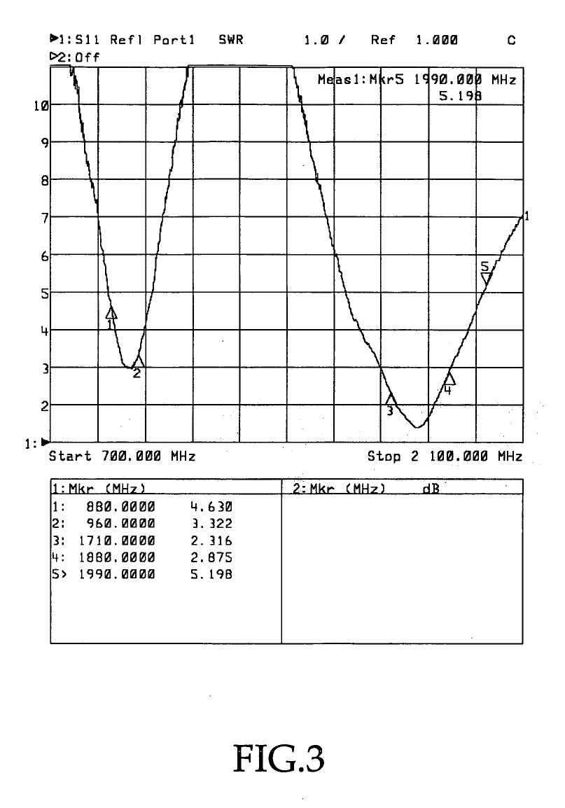

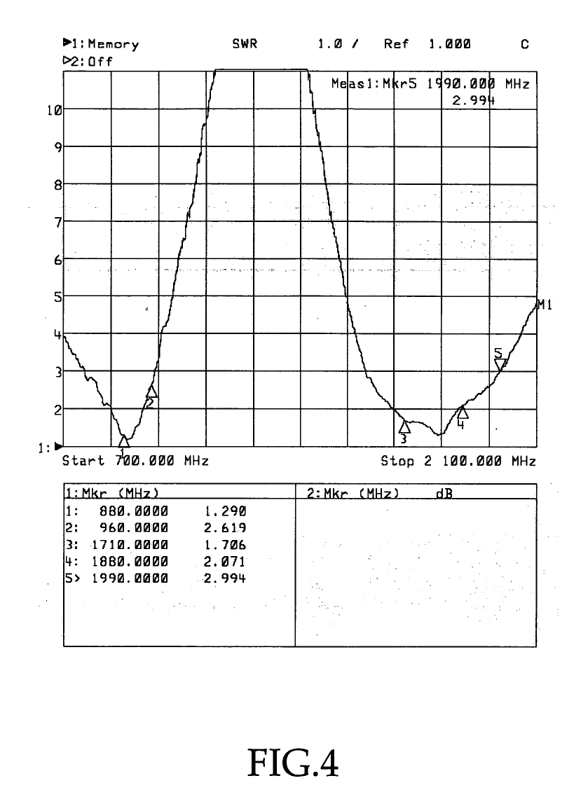

FIG. 3 shows a test result before adding the short-trace 12 of the present invention to a planar antenna; FIG. 4 shows a test result of the antenna of the present invention. The standing wave voltage ratio (VSWR) of the present invention at 880 MHz is 1.29; 2.619 at 960 MHz, 1.706 at 1710 MHz and 2.071 at 1880 MHz and 2.994 at 1990 MHz. These standing wave voltage ratio (VSWR) are all approximate to 2; it is a much more ideal broadband antenna than those antennas not added with short-traces with the identical frequencies as above respectively and have the values respectively of 4.630, 3.322, 2.316, 2,875 and 5.198 (referring to FIG. 3).

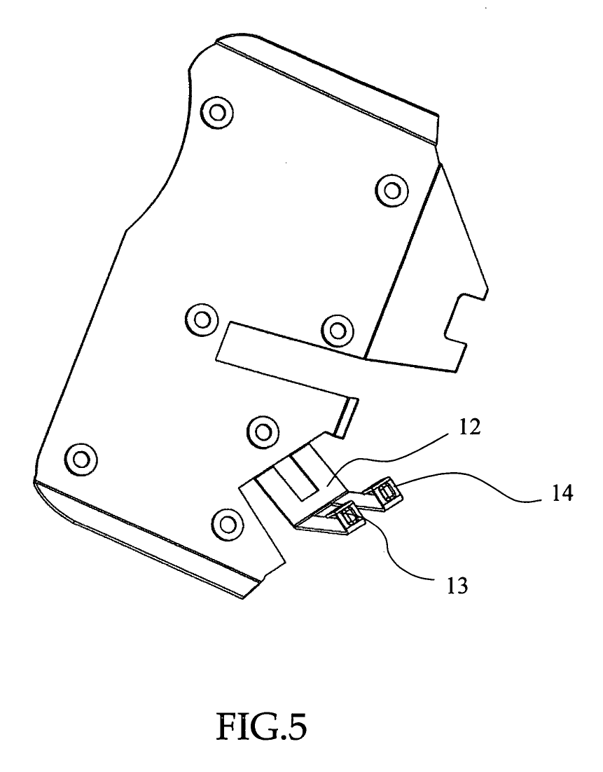

The shapes of the radiating elements 11 in the planar antenna 10 with the short-trace 12 of the present invention are not limited to those depicted in FIG. 1, for this please refer to another embodiment of the present invention depicted in FIG. 5.

The preferred embodiment cited above is only for illustrating the present invention. It will be apparent to those skilled in this art that various modifications or changes can be made to the elements of the present invention without departing from the spirit and scope of this invention; and all such modifications and changes also fall within the scope of the appended claims and are intended to form part of this invention.

1. A planar antenna with a short-trace applied to multi-band mobile handset electronic devices, said structure includes two main resonant elements that are bent around each other and said short-trace, said short-trace is connected between a feed-point and a ground-point; by influence of a loop surface current induced by said short-trace, said antenna gets a broadband effect at multi-frequencies.

2. The planar antenna with a short-trace as in claim 1, wherein resonant frequencies of said antenna take a quarter wavelength as a unit of changing in adjusting to change sizes of said two main resonant radiating elements.

3. The planar antenna with a short-trace as in claim 1, wherein changing position of said short-trace makes bandwidth be increased for being applied to a GSM band.
